(19) United States
(12) Patent Application Publication
(10) Pub. No.: US 2006/0260111 A1
(43) Pub. Date: Nov. 23, 2006

(54) Assembly lock removal apparatus

(76) Inventor: Terry Russell, North Pole, AK (US)

Correspondence Address: LAW OFFICE OF STEVEN B. LEAVITT, L.L.P.;ATTN: JOHN PEMBERTON, 7405 BUCKSKIN COURT, FORT WORTH, TX, 76137, US

(21) Appl. No.: 11/131,104

(22) Filed: May 17, 2005

(51) Int. Cl. B23P 19/00

(52) U.S. Cl. 29/426.4; 29/426.1

(57) ABSTRACT

The present invention relates to a hand tool with a sharp concave chisel end for the quick and easy removal of lock rings, where the concave end of the tool prevents slippage of the tool when utilized to disassemble or break a lock ring. The sharp concave chisel end is utilized to with a striking object such as a hammer to partially or completely split an edge of a lock ring and disassemble the lock ring from its position.

### BACKGROUND OF THE INVENTION

1. Technical Field

The present invention relates to an apparatus designed to remove lock rings in a safe and effective manner. More particularly, the present invention relates to a tool that utilizes a curved sharp end for the disassembly or removal of lock rings commonly found on automotive and light truck assemblies such as brake drums and rotors.

2. Description of Related Art

Lock rings and their many different uses as an assembly lock are widespread and well known. For example, in one application, lock rings are used on automobiles and trucks to assist in the assembly of brake drums and rotors when the vehicle is originally manufactured. The lock rings are unnecessary for operation of the vehicle and are later removed by mechanics working on the vehicle. However, despite the widespread use of lock rings, the prior art is absent of any device that utilizes a tool specifically for them without the use of some type of pliers.

The pliers typically used to remove lock rings are long and narrow in shape with tips sufficiently small to pinch one end of a lock ring and then remove the lock ring. However, this takes are certain amount of skill as the pliers are difficult to control in tight spaces and their use can be time consuming as the operator sometimes has difficulty in pinching one end of the lock ring. What is needed is a device that could easily remove cut the lock ring and does not require the use of pliers. It would be beneficial if the device could cut the lock ring and allow it to easily be removed.

The pliers of the prior art are not strong or sharp enough to cut a lock ring. Furthermore, a standard flathead screwdriver of any size would not be sharp enough to cut a lock ring and the flat nature of the tip of the screwdriver would potentially cause slippage of the head of the screwdriver off of the lock ring resulting in injury to a user. A chisel poses the same problems as a screwdriver, in the potential for slippage and general size problems that are present.

Much of the prior art includes:
JP 2004/330646 A2 which provides a chisel set consisting of a plurality of chisels with gripping parts different in shape from one another in combination.
U.S. Pat. No. 5,933,935 which provides a retainer ring tool for installing and removing retainer rings or snap rings. The retainer ring tool is not designed to cut a lock ring.
U.S. Pat. No. 5,062,191 which provides a locking ring tool that resembles the pliers common in the prior art.
U.S. Pat. No. 4,875,289 which provides a chisel for removing damaged bolts, nuts and screws.
U.S. Pat. No. 4,363,364 which provides a plow chisel with pointed shank having pointed chisel cap secured thereto by weld.
U.S. Pat. No. 3,484,924 which provides a set of pliers for the removal of locking rings.
U.S. Pat. No. D346,103 which represents an ornamental design for a chisel.
U.S. Pat. No. 2,546,616 which provides a tool that is essentially a set of narrow nose pliers, for handling open ended spring retaining rings.
   None of the above referenced art is designed to cut a lock ring and most require a certain amount of skill to operate and are difficult to operate in tight spaces.

### SUMMARY OF THE INVENTION

The present invention describes the use of a tool that utilizes a curved sharp end for the disassembly or removal of assembly locks and lock rings commonly found in hardware and automotive applications. The present invention offers an alternative to the older technology of lock ring pliers that are difficult to control in tight spaces and require a much steadier hand than that of the present invention. An embodiment of the present invention utilizes a concave edge of a hand tool, where the concave edge is likened to a sharp blade that may be utilized to slice through the edge of a lock ring thereby breaking the lock ring at the point of contact for easy removal. An additional embodiment of the invention includes the use of the tool with a hammer.

In use, the sharp concave edge of the end of the tool is placed against the edge of the lock ring. Then a hammer or some other similar striking object strikes the butt-end of the tool with enough force to break the lock ring at the area of impact where the tool is focused. Another embodiment of the present invention would be to utilize the sharp concave edge of the tool in a groove of a lock ring and then twist the tool in a manner such that the concave edge would essentially pry the lock ring off from where it was fastened.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a representation of a top view of the present invention;

FIG. 2 is a representation of a full side view of the present invention; and

FIG. 3 is a flow chart depicting the steps involved in one embodiment of the present invention.

### DETAILED DESCRIPTION

In the descriptions that follow, like parts are marked throughout the specification and drawings with the same numerals, respectively. The drawing figures are not necessarily drawn to scale and certain figures may be shown in exaggerated or generalized form in the interest of clarity and conciseness.

The present invention relates to a hand tool for the removal of lock rings commonly found in the appliance and automotive industry. Lock rings are often used on brake drums and rotors of automobiles and trucks. Such lock rings are installed when the vehicle is originally manufactured and are removed by mechanics working on the vehicle.

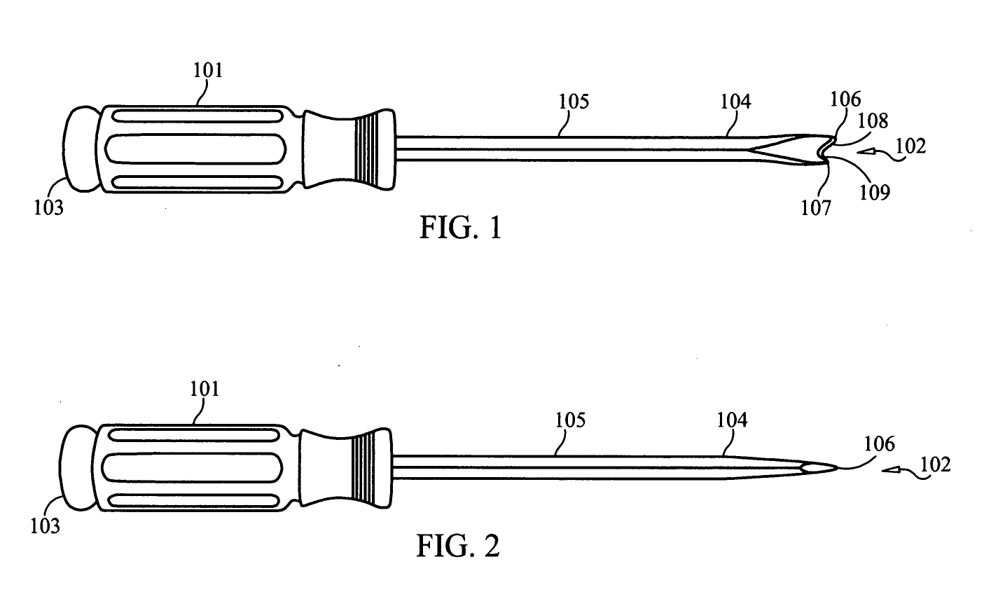

FIG. 1 represents a top view of the present invention of the assembly lock remover 101, where shaft 105 of assembly lock remover 101 may be round, square, or some other symmetrical shape similar to that of a screwdriver. Shaft 105 is made of steel, steel alloy, or some other similar strong rigid material. Shaft 105 of assembly lock remover 101 extends to point 104 where shaft 105 becomes more narrow similar to a chisel. However, tip 102 differs from a chisel in that an area is removed to provide a sharp concave end instead of a flat chisel end.

Tip 102 includes protruding ends 106 and 107 and cutting edges 108 and 109. Protruding ends 106 and/or 107 allow for assembly lock remover 101 to rest on and against a lock ring preventing tool 101 from slipping off the lock ring while tool 101 is in use. Protruding ends 106 and 107 preferably have sharpened tip points. In a preferred embodiment, a groove or notch for accepting the edge of a lock ring is disposed between protruding ends 106 and 107. In another embodiment, there may be only one protruding end.

Cutting edges 108 and 109 extend from protruding ends 106 and 107, respectively, inward towards the center of tool 101 at an angle between about 1 degree and about 89 degrees. Preferably, the angle is between about 20 degrees and about 60 degrees and more preferably, the angle is about 45 degrees. The angle can be any degree greater than 0 degrees and less than about 90 degrees so long as the angle creates at least one protruding end such as protruding end 106.

A hammer or some other similar striking object may be used to drive the tool 101 into and cut a lock ring using one or both cutting edges 108 and 109. The hammer is struck against the terminal planar end (butt-end) of the handle 103, which is adapted for receiving an external force. The force from the blow is conveyed through handle 103 and is projected outward through one or both cutting edges 108 and 109.

FIG. 2 represents a top down view of the tool 101 with the shaft 105 and narrowing point on the shaft 104.

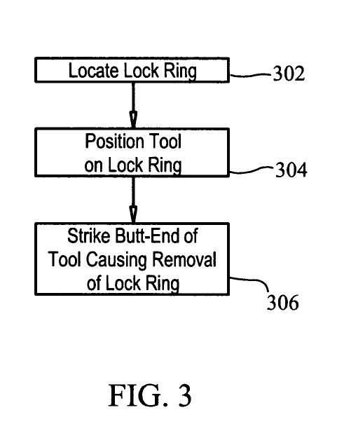

In use, as depicted in FIG. 3, a lock ring is located, Step 302. Then the assembly lock remover 101 is positioned on the lock ring such that the protruding end 106 or 107 is positioned against the lock ring, Step 304. The butt-end of handle 103 of the assembly lock remover 101 is struck with sufficient force to cause the lock ring to slide along cutting edge 108 or 109 causing lock ring to be split in two and be easily removed, Step 306. The butt-end of handle 103 is preferably flat to more easily accept the striking blow of the hammer or other similar object.

Because either protruding end 106 or 107 can be securely positioned against a lock ring, assembly lock remover 101 can be operated within confined spaces. Also, the assembly lock remover 101 does not require a great amount of skill to remove the lock ring and only requires the striking of a hammer.

Additionally, the lock remover 101 can be used to remove other assembly locks. For example, to remove the assembly lock around a 55-gallon drum, the same method is followed as above except sometimes the assembly lock will not break into two pieces. If the assembly lock does not break into two pieces, then the lock remover 101 is twisted by the handle 103 around the circumference of the shaft 105 to assist in the removal of the assembly lock. The twisting action increases the tension on the assembly lock to the point were increased tension caused the assembly lock to break into two and allowing for removal.

Although the invention has been described with reference to one or more preferred embodiments, this description is not to be construed in a limiting sense. There is modification of the disclosed embodiments, as well as alternative embodiments of this invention, which will be apparent to persons of ordinary skill in the art, and the invention shall be viewed as limited only by reference to the following claims.

What is claimed is:

1. An apparatus for the quick and easy removal of a lock ring, wherein the apparatus comprises:
a shaft having a first end and a second end,
a handle disposed at the first end of the shaft, and
a sharp concave chisel edge disposed at the second end of the shaft, where the sharp concave chisel edge has at least one protruding end.

2. The apparatus of claim 1, wherein the sharp concave chisel edge is between about 1 degree and about 89 degrees from the shaft relative to the at least one protruding end.

3. The apparatus of claim 2, wherein the angle is between about 20 degrees and about 60 degrees.

4. The apparatus of claim 2, wherein the angle is approximately 45 degrees.

5. The apparatus of claim 1, wherein the protruding end has at least one sharpened point adapted for removing a lock ring.

6. The apparatus of claim 1, wherein the protruding end has a groove to accept the edge of a lock ring.

7. The apparatus of claim 1 wherein the handle has a flattened portion to accept a strike from a hammer.

8. The apparatus of claim 1 wherein the shaft is made of metal.

9. The apparatus of claim 1 wherein the shaft is made of a metal alloy.

10. A method for the quick and easy removal of a lock ring, the method comprising the steps of:
positioning a lock ring removal tool on a lock ring, wherein the lock ring removal tool has
a shaft having a first end and a second end;
a handle at the first end of the shaft; and
a sharp concave chisel edge at the second end of the shaft, where the sharp concave chisel edge has at least one protruding end; and
striking the handle with sufficient force to break the lock ring into two pieces.

11. The method of claim 10, wherein the sharp concave chisel edge is between about 1 degree and about 89 degrees from the shaft relative to the at least one protruding end.

12. The method of claim 11, wherein the angle is between about 20 degrees and 60 degrees.

13. The method of claim 11, wherein the angle is about 45 degrees.

14. The method of claim 10, wherein the protruding end has at least one sharpened point adapted for removing a lock ring.

15. The method of claim 10, wherein the protruding end has a groove adapted to receive the edge of a lock ring.

16. The method of claim 10 wherein the handle has a flattened portion to accept a strike from a hammer.

17. The method of claim 10 wherein the shaft is made of metal.

18. The method of claim 10 wherein the shaft is made of a metal alloy.

19. A method for removing a lock ring, the method comprising the steps of:
positioning a lock ring removal tool on a lock ring, wherein the lock ring removal tool has
a shaft having a first end and a second end;
a handle at the first end of the shaft; and
a sharp concave chisel edge at the second end of the shaft, where the sharp concave chisel edge has at least one protruding end;
striking the handle with sufficient force to drive the second end of the lock ring removal tool into at least a portion of the lock ring; and
twisting the lock ring removal tool by the handle around the circumference of the shaft to remove the lock ring.

20. The method of claim 19 wherein the shaft is made of a metal alloy.
